(19) United States
(12) Patent Application Publication
(10) Pub. No.: US 2014/0097217 A1
(43) Pub. Date: Apr. 10, 2014

(54) Tool Holding Device

(71) Applicant: Sean Michael Walsh, Grass Valley, CA (US)

(72) Inventor: Sean Michael Walsh, Grass Valley, CA (US)

(21) Appl. No.: 14/019,423

(22) Filed: Sep. 5, 2013

Related U.S. Application Data
(60) Provisional application No. 61/743,530, filed on Sep. 6, 2012.

(51) Int. Cl. A45F 5/02; F16B 45/00; B25H 3/00

(52) U.S. Cl. CPC A45F 5/02; B25H 3/006; F16B 45/00
USPC 224/268; 248/305

(57) ABSTRACT

A tool holding device is disclosed that securely but removeably holds tools such as cordless drills and nail guns to a tool user by means of a hook and or lanyard. The device is comprised of a belt mounted holder, a mechanical fastening device that is fastened to the handle of a tool, and a J-shaped hook that removeably attaches on one end to the handle mounted mechanical fastening device and on the other end to a belt mounted holder. This invention allows the tool user to securely hold their tools to themselves without endangering those working near by. The belt mounted holder provides a spring biased structure to secure itself to a belt or clothing as well as structure to securely receive one end of the J-shaped hook which can be removeably attached to the handle of a tool by the handle mounted mechanical fastening device attached to the other end.

### CROSS-REFERENCE TO RELATED APPLICATIONS

This application claims the benefit of U.S. provisional patent application Ser. No. 61/743,530 filed on 2012 Sep. 6 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

The present invention pertains to securing tools to promote convenient, as well as safe working conditions in various tool related industries. More precisely the present invention relates to a device that can be secured to most tools, allowing a multitude of safety devices and tool accessory devices to be secured to the tool.

2. Prior Art

A multitude of tool holding devices have been made available to the construction industry. For the most part these tool holders only work with a small subset of tools that are commonly used because of limited strength and limited range of adjustment on the portion that actually holds the tool. In general these tool holding devices are constructed out of plastic, aluminum, light weight metals and elastic, and are not capable of enduring the constant abuse that takes place in construction. There has yet to be introduced a tool holding device that can effectively secure tools to a user, allow easy removal of the holding device from the tool when it is not being operated and which will also prevent tools from becoming dislodged unintentionally when users are moving. There has also yet to be introduced a device that would allow the user the flexibility to interchangeably attach various types of tool securing devices and accessories to their chosen tool. There remains an unmet need to provide workers with a tool securing device that would allow them the ability to carry both large and small tools up ladders with both hands free to prevent losing their grip from a ladder, falling and being injured or killed. There is no known prior art or invention that can safely and securely hold power tools that weigh upwards of twenty pounds to a tool user so they may carry their tool up a ladder and work in dangerous situations using both hands. There is also a need for securing tools that provides a releasable mechanical means of secure attachment that prevents the device from falling and causing injuries to the tool user or others working in the vicinity, yet not being cumbersome to work with. Other devices in the prior art do not effectively decouple the swinging motion of attached tools from the user during user movement. Other tool holder devices in the prior art do not hold the attached tool out and away from the user thus causing frequent collisions between the tool and user as the user moves about on a job site. No known tool holder device in the prior art can operate to removeably secure and lock the tool to the user or alternatively securely fastening and locking to a common building material such as a rafter or joist without interruption or adjustments of the device. One embodiment of the current invention has a biting structure mounted on the hook that engages with the building material to which the hook is attached and bites further into the material as more downward force is exerted by the attached tool. This biting structure makes heavier tools even more securely attached than light tools and allows attachment of the hook to steeper pitched rafters than the prior art devices would allow.

U.S. Pat. App. No. US 2004/005088 to Warner (2004) shows a universal tool attachment device for supporting tools on items separate from the tool user. Once the belt member is wrapped around the tools handle a buckling system is used to keep the hook securely held to the tool handle. The tool can then be hung from various surfaces by the hook. A tool could be held by this hook, however there is nothing provided to keep the tool from becoming dislodged from the surface it is hung on and injuring a person working below. Since the hook relies on gravity alone to hold it to the user and has no other securing structure, it also does not prevent tools from being dislodged and falling and breaking on the ground. For example, as a user is descending a ladder, the tool could snag on part of the ladder or nearby building structure and the hook will be lifted up and off of whatever it is hanging on such as a belt or pocket. This invention also does not provide the user the ability to interchangeably use different attachments such as a lanyard, or a hook or a flashlight for safety and convenience. Another shortcoming of the Warner invention is the inability to safely and securely attach a device to a tool handle that can support the tools weight without it being cumbersome and awkward to work with. The Warner invention does not permit pivoting of the attached tool to accommodate mass imbalances and allow the tool to pivot to a position of equilibrium.

Similarly U.S. Pat. App. No. US 2008/0000939 A1 also to Walsh discloses a tool holder that is adapted to secure to the handle of a tool. It is comprised of a U-shaped hook and a hook-and-loop fastening strap that wraps around the handle of the tool, securing the U-shaped hook to the handle of the tool. This invention still leaves an unmet need to be able to secure tools, preventing them from dangerous falls. It also will not allow the user to be able to secure it to any tool common to the construction industry. When used on a very small tool handle, there would remain a large amount of excess strap that becomes cumbersome to work with. When secured on a very large handle the strap could be too short and not able to adequately stay attached to the handle. Also, the present invention does not allow the user to attach anything else to it, only the U-shaped hook. This prior art device suffers from the same shortcomings of the Warner invention in that it does not permit pivoting of the attached tool to accommodate mass imbalances and allow the tool to pivot to a position of equilibrium. Also, the hook can be dislodged as a user is descending a ladder. The tool could snag on part of the ladder or nearby building structure and the hook will be lifted up and off of whatever it is hanging on such as a belt or pocket.

Additionally U.S. Pat. No. 8,070,027 to Piatt (2011) shows an adaptable tool hook constructed from a wire frame which incorporates a hook and buckling system with a strap. Once again the present art does not meet the need to safely and securely protect tools and workers from damaging falls. Also the present art does not meet the need to be able to securely hold tools to objects that are common to the construction industry. Tools that are extremely heavy would also not be able to be secured with this invention either as it is shown to have a VELCRO strap which would not be able to hold upwards of twenty pounds. As with other prior art devices the hook of the Piatt invention can be dislodged as a user is descending a ladder. The tool could snag on part of the ladder or nearby building structure and the hook will be lifted up and off of whatever it is hanging on such as a belt or pocket. Piatt also does not hold the attached tool out and away from the user which would result in frequent collisions between the user and the attached tool.

U.S. Pat. App. No. US 2005/0011919 A1 Durham shows a holder for an electric drill that is secured to a belt. This invention's use is limited only to cordless drills that have a large battery at the bottom of their handle. This invention does not meet the need to have a universal tool securing system that works with all power tools, nor does it allow the tool to be supported on anything but the holder. The tool could snag on part of a ladder or nearby building structure as the user is descending and the tool will be lifted up and out of the hook since there is nothing but gravity securing it. Durham does not hold the attached tool out and away from the user which would result in frequent collisions between the user and the attached tool. Since nothing is attached to the tool, the Durham invention can't secure the tool to a rafter. The Durham invention is simply a wire holster worn by the user into which only a certain kind of tool (with an enlarged battery at one end of its handle) can be fitted without sliding out.

U.S. Pat. No. 6,880,794 to Kahn (2005) discloses a universal tool holder for carrying a tool or other article, for example, a cordless drill, nail gun, hammer or shovel is comprising a stretchable cord that is formed into a looped end and adapted to be wrapped about the handle of a tool in such a manner that it tightly engages the tool, and a second end having a retainable object, such as a ball, that is configured to be safely and securely held within a retaining receiver. The retaining receiver is in the form of a socket-type receiver configured to correspond to the geometrical shape of the retainable object such it can removably secure the retainable object. The socket-shaped retaining receiver can be incorporated into a variety of articles useful in carrying and storing tools, including a belt clip, a wall mounting implement or a ladder mounting implement. By integrating the retaining receiver into such a variety of articles, any tool carried by the universal tool holder can be removably secured to the retaining receiver, thereby enabling a user to suspend the tool from a belt clip, ladder or wall. The uses of the above invention are limited to specifically shaped tools that do not exceed certain weights, and the design does not allow the tool to attach to anything besides it's socket-shaped receiver. There are a variety of tools that this invention can not safely secure itself to, such as electric drills with a lower flanged end, air ratchets, air impact wrenches and air powered chisels. This invention cannot support tools of substantial weight such as chain saws that can weigh up to 35 pounds, as well as circular saws that can weigh 22 pounds, and large nail guns that weigh up to 14 pounds (depending upon the manufacturers and models) as the bungee would stretch, come undone and possibly break. Although Kahns invention has enjoyed some commercial success, users complain about tool and user collisions and that the elastic bungee acts as a spring when positive gs are exerted on the tool with the subsequent rebound launching the tool out of the holder. Users also complain that the bungee interferes with their ability to comfortably grip the tool handle.

U.S. Pat. No. 6,062,449 also to Kahn (2000) contains a tool-toting device for carrying and retaining a hand tool comprising a clip, a swivel element and a U-shaped hook, the clip being capable of attachment to a belt, such as a tool belt. The swivel element is swivelably connected to the clip by conventional means, such as a semi-tubular rivet such that it freely swivels about a 360.degree. axis, while the U-shaped hook is rotatably connected to the swivel element by means of a jam nut-acorn nut arrangement such that it is capable of rotating about a 360.degree. axis. In this manner, a tool hanging from the U-shaped hook will swivel about the 360.degree. axis, thereby maintaining its center of gravity as the user moves about a construction area. The user can re-position the hook for comfort and accessibility simply by rotating the hook about its axis. Due to the design of this invention, there are a limited number of tools that can be securely and safely retained by this tool tote. As with other prior art devices, this Kahn invention relies on gravity alone to keep the tool in the hook and suffers the same shortcomings when a user is descending a ladder.

U.S. Pat. No. 6,454,147 Marks is very similar to Kahn above and relies on gravity alone to keep the tool in the hook. Marks suffers the same shortcomings as Kahn when a user is descending a ladder. There is nothing in Marks that is fastened to the tool which makes hanging the tool on a rafter beyond the capability of the Marks invention.

U.S. Pat. No. 5,201,445 to Axelman (1993) shows a tool holder with a self-stabilizing swivel mount for accommodating an air driven hand-held power tool. An cone shaped receptacle mouth is disclosed for slidably receiving a hook that is affixed to the tool. The receptacle is rotatably displaceable upon weight transference from the tool and is adapted to assume an equilibrium rest position. A gravity actuated locking device is shown within the receptacle for securing the inserted hook. The locking device self releases when the receptacle is re-oriented to a substantially vertical position for removal of the power tool. Nothing in Axelman position the tool out and away from the user. Nothing in Axelman discloses a universal tool mechanical fastening device and instead only shows a hook bolted to the top of a pneumatic tool. Nothing disclosed in Axelman would allow the tool to be securely attached to anything besides the cone shaped receptacle.

U.S. Pat. App. No. US2008/0277546 Al and U.S. Pat. App. No. 2007/0125819 A1 to Kahn show various coupling members that are affixed to a hand held tool providing means for the tool to be hung from a receiving member which can be held to a users belt or pants. As with other prior art devices, these Kahn inventions rely on gravity alone to keep the tool in the Patent receiving member. They suffer the same shortcomings when a user is descending a ladder, or working around objects that may bump the tool causing it to become dislodged from the receiving member. These inventions are also limited in function and will not allow for the tool to be secured to anything besides the receiving member. The present inventions also will not keep a tool out and away from the user to prevent constant collisions in between the tool user and the tool.

U.S. Pat. App. No. US2010/0044405 A1 to Albert shows a belt mounted holster for securing power tools. This invention is comprised of a belt mount and tool clip that is secured to the body of a tool. Nothing in Albert discloses a universal mechanical fastening device and instead only shows a clip that would need to be custom made for every variation of common tools which would be very costly to manufacture. Nothing disclosed in Axelman would allow the tool to be securely attached to anything besides the provided belt mount. Once again, Alberts invention like the others, only depends on gravity to hold the tool to the user and does not provide means to lock the tool within a holder to prevent accidental dislodgments of the tool. Albert also does not provide means for a tool to pivot thus decoupling the tools swinging motions.

Despite the teachings of the prior art there still remains a need for a tool holder that can removeably secure a wide array of common construction tools to a user, hold the secured tool out and away from the user as well as accommodate rigorous motion without causing tool-user collisions and inadvertent tool releases. Also the prior art does not meet the need for a tool holder that would allow various tools to be secured to common items in the construction industry, such as, rafters, joists, plywood, shingles, electrical wires, water pipes; as well as allowing the tool to be secured to the tool user, ladder rungs, and ladder tops. The prior art also does not fulfill the need for a tool holder that can be attached to nearly any hand held tool, no matter the weight, shape, or size, and also allow the tool to be secured to whatever is handy. There is still an unmet need to provide handymen, tradespeople, and construction professionals with a tool securing device that will prevent tools from being dropped, while also providing the ability to removably attach various safety devices and accessories to a tool.

### OBJECTS AND ADVANTAGES

Accordingly, several objects and advantages of the invention are to provide the construction, handyman, DIYers, and like industries with a uniquely designed universal tool accessory mounting device that will meet and exceed their tool securing needs. Several objects and Patent advantages of the present invention are:
(a) to provide tool users with an all purpose tool accessory mounting device, that will allow for convenient adaptation to a wide array of hand held tools in many industries;
(b) to provide tool users with a tool securing device that will not fail or detach under the heavy loads of tools.
(c) to provide a tool holding device that will allow a secured tool to pivot to decouple tool swing motion from the user yet be held out and away from a user to minimize tool-user collisions.
(d) to provide tool users with a tool accessory mounting device capable of removeably receiving a plurality of tool accessories.
(e) to provide a tool holding device that works in conjunction with a belt mounted holder, whereby a tool user can secure their tool to themselves by releasably locking the tool within the belt mounted holder;
(f) to provide a tool holding device that has means to attach accessories such as flashlights to tools and permits them to pivot for optimal orientation
(g) to provide a tool holding device that can also be used to releasably receive accessories that are capable of holding drill bits, nails, screws, and other materials and tools within them, whereby the tool user could store these items without needing to wear tool bags, or use their pockets;
(h) to provide a tool holding device that is advantageous in design, adaptability to different shapes and sizes of tools as well as being mechanically robust and durable.
(i) to provide tool users a tool accessory mounting device that can releasably receive a tool securing accessory that will allow tool users to attach the tool to their pants pocket, tool bags, their belt, lumber, plywood, and other materials common to the construction industry;
(j) to provide a tool accessory mounting device that can receive a lanyard that will prevent tools from being dropped by being securely held to the tool accessory mounting device by mechanical means.

Further objects and advantages is to provide a device that will universally allow tool users the option to choose throughout the day what safety or convenience accessory they would like to use. Still further, the tool accessory mounting device disclosed within provides unmatched securing and safety options by allowing tool users the ability to both lock their tools within a belt mounted holder while at the same time having a lanyard attached to the tool to prevent the tool from being dropped when it is not locked into the holder. Also the present invention allows tool users to securely lock both large and small tools within the belt mounted holder so they may use both hands to climb ladders safely, as well as work on roofs and other dangerous areas with both of their hands free. The present invention allows a user to secure a heavy tool to steep rafter or a belt without changing the configuration of the device. Yet further, the tool accessory mounting device allows tool users to be able to keep their tools safely and conveniently mounted to them yet easily removed for use which creates safer and more productive working conditions.

### SUMMARY

Accordingly the present invention discloses a tool holding device which can securely affix to a tool handle and allow a user to removeably hang the tool from a rafter, belt, ladder rung, pant pocket, tool bag or other convenient site without the danger of inadvertent detachment therefrom. The invention will also allow a multitude of tool safety and convenience accessories to be interchangeably attached to tools.

### BRIEF DESCRIPTION OF THE DRAWINGS

FIG. 1 is a side view of the mechanical fastening device of the present invention.

FIG. 2 shows a detailed view of working parts of the mechanical fastening device.

FIG. 3 shows the mechanical fastening device attached to the handle of a powered tool.

FIG. 4 is a perspective diagram of how the tool holding device can mechanically receive an accessory.

FIG. 5 shows a cutaway view of a J-shaped hook accessory.

FIG. 6 shows the tool holding device with an accessory mechanically attached to it.

FIG. 7 is a perspective diagram showing a belt mounted holder that is used in conjunction with accessories that attach to the mechanical fastening device.

FIG. 8 is a perspective diagram of a spring biased structure that is used to secure the belt mounted holder to a belt or article of clothing.

FIG. 9 shows the method by which the accessory of FIG. 6 is used in conjunction with the belt mounted holder of FIG. 7.

FIG. 10 is a close up view of the mechanical connection in between the accessory of FIG. 6 and the belt mounted holder of FIG. 7.

FIG. 11 is a perspective diagram of a tool lanyard accessory that mechanically attaches to the tool accessory mounting device of the present invention.

FIG. 12 is a perspective diagram of a tool accessory pouch mechanically adapted to the tool accessory mounting device.

FIG. 13 shows a flashlight attached to a tool which can pivot to optimally light the area on which the tool is working.

FIGS. 14-18 shows additional preferred embodiments of the present invention

### DETAILED DESCRIPTION

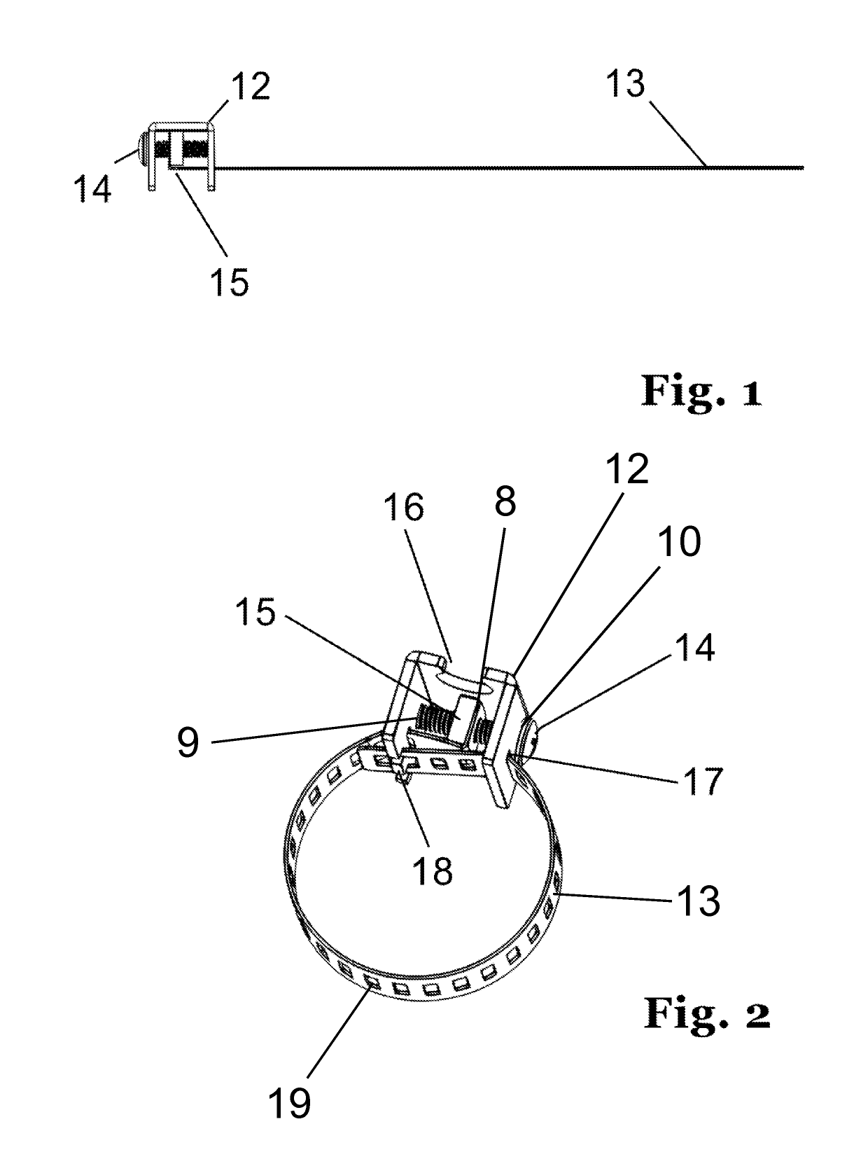

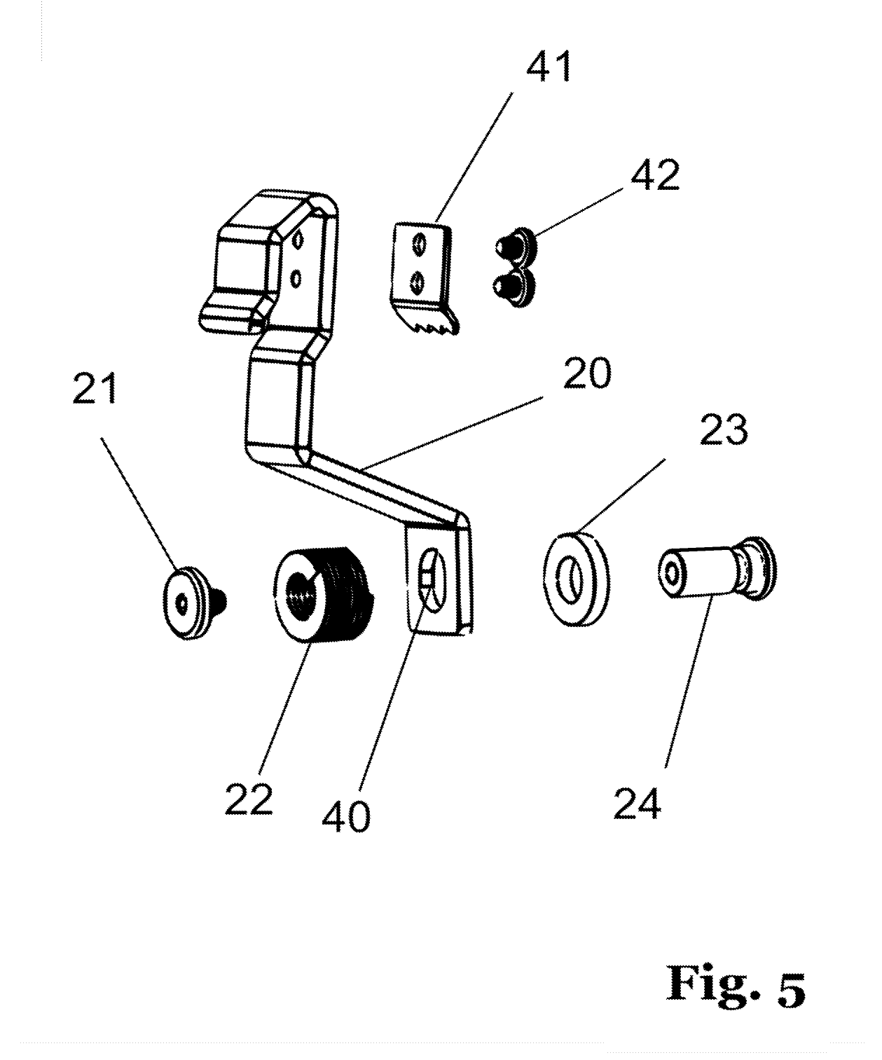

### FIGS. 1-13—Preferred Embodiments

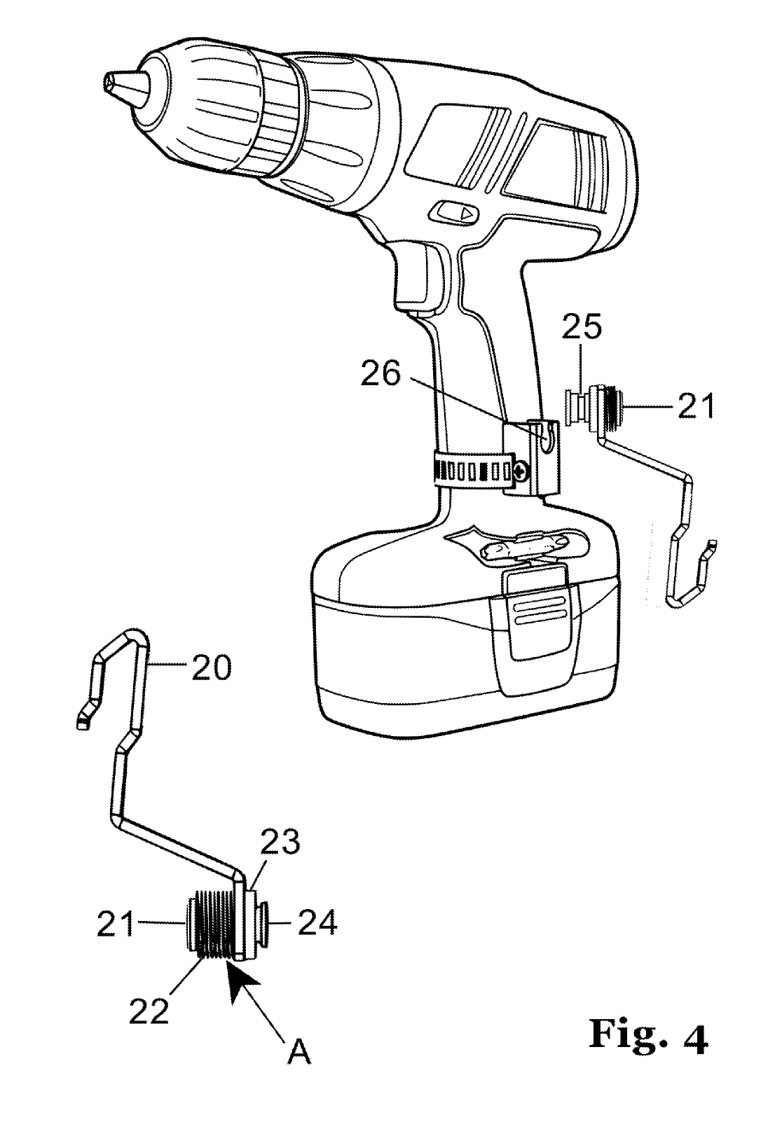

Referring now to FIGS. 1 & 2 showing two views illustrating the mechanical fastening device of the present invention. The mechanical fastening device of FIGS. 1 & 2 is comprised of several working parts. 12 is a bracket providing apertures sized to receive additional parts detailed herein. 13 is a flexible band providing spaced slots 19 of predetermined shape and size that passes through an aperture 11 in the bracket 12 and is mechanically held within the bracket 12. The bracket of FIGS. 1 & 2 also provides an aperture 17 that allows the loose end of the band 13 to pass through, and a flange 18 that allows one of the slots 19 of the band 13 to seat in it so that the band can be tightened when the other end is pulled. The other end can be pulled by turning the screw 14 so as to move the nut 15 against the flange 8 which tightens the band 13. The bracket 12 provides apertures 9 & 10 to receive an adjustment screw 14. The adjustment screw 14 engages a threaded nut 15 which engages the band 13 by means of a flange 8 providing a hole for the screw 14. The bracket 12 of FIGS. 1 & 2 provides a cutout 16 of predetermined shape and size that releasably receives a fastener 24 of FIG. 4 also of predetermined shape and size.

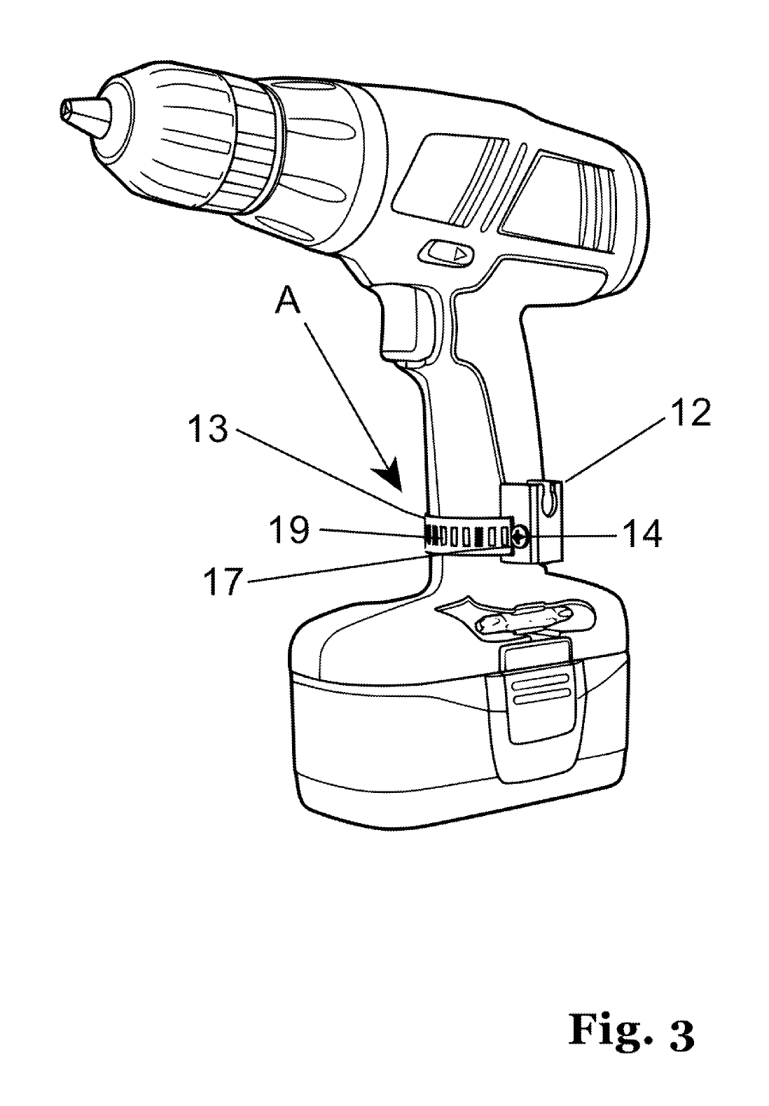

Referring now to FIG. 3 which illustrates the mechanical fastening device attached to the handle of a powered tool FIG. 3A. The band 13 is shown tightly wrapped around the perimeter of a powered tools handle with it's loose end passed through the provided aperture 17 in the sidewall of the bracket 12. The mechanical fastening device Fig. is held tightly to the handle of the tool by means of the bands 13 spaced slots 19 having engaged the tab 18 of FIG. 2 and being tightened by turning the screw 14.

Referring now to FIGS. 4 & 5 illustrating an adaptable hook accessory assembly shown by itself in FIG. 4A comprised of several parts. A hook 20 has an aperture 40 through which fastener 24 passes. Once the fastener 24 is passed through the aperture 40, a spring 22 and a washer 23 can be retained coaxially around the fastener by enlarged end portions 21 and 24 on each end of the fastener. The fastener can be a two piece structure, which allows a secure connection of the two pieces 21 and 24 through the aperture by having one of the pieces 21 with male threads and the other piece 24 having mating female threads to allow the male threads of 21 to be inserted and tightened into a matched threaded bore of piece 24. This allows simple assembly of fastener 24 through the aperture 40 which is smaller than the enlarged end portions of 21 and 24 located at either end. The enlarged end pieces provide retaining structures for the spring 22 and washer 23 and also provide on one end a button surface which can be displaced by a user against the bias of spring 22 to extend the fastener further through the aperture 40 and move the other end portion away from the hook to allow the easy separation of the hook 20 and the mechanical fastening device of FIGS. 1 & 2. When pressure is placed on the fastener 21 the spring is compressed exposing a reduced diameter portion 25 on the fastener 24 that passes through the opening of the cutout 26 on the face of the bracket 12 of FIGS. 1 & 2. The washer 23 is preferably non metallic and prevents metal to metal contact between the hook 20 and the bracket 12. The device will operate without the use of a washer but the washer improves smooth operation.

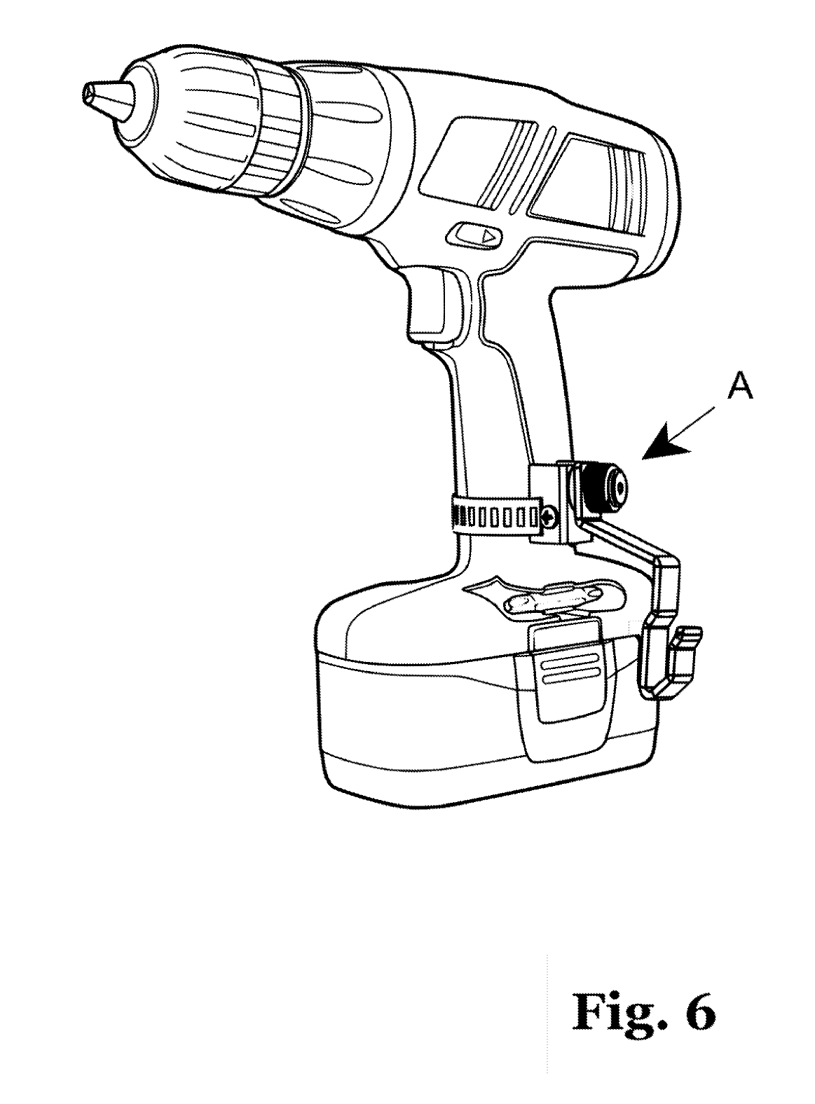

Referring now to FIG. 6A which illustrates the hook accessory of FIG. 4 attached to the tool accessory mounting device of FIG. 1.

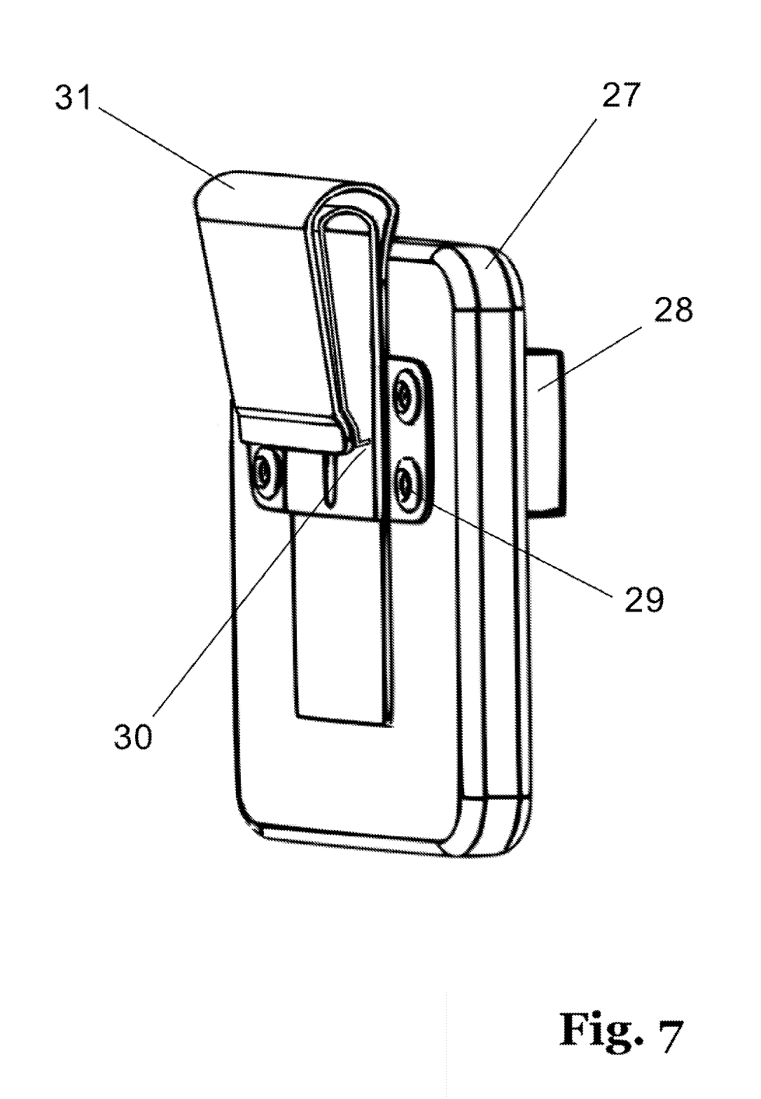

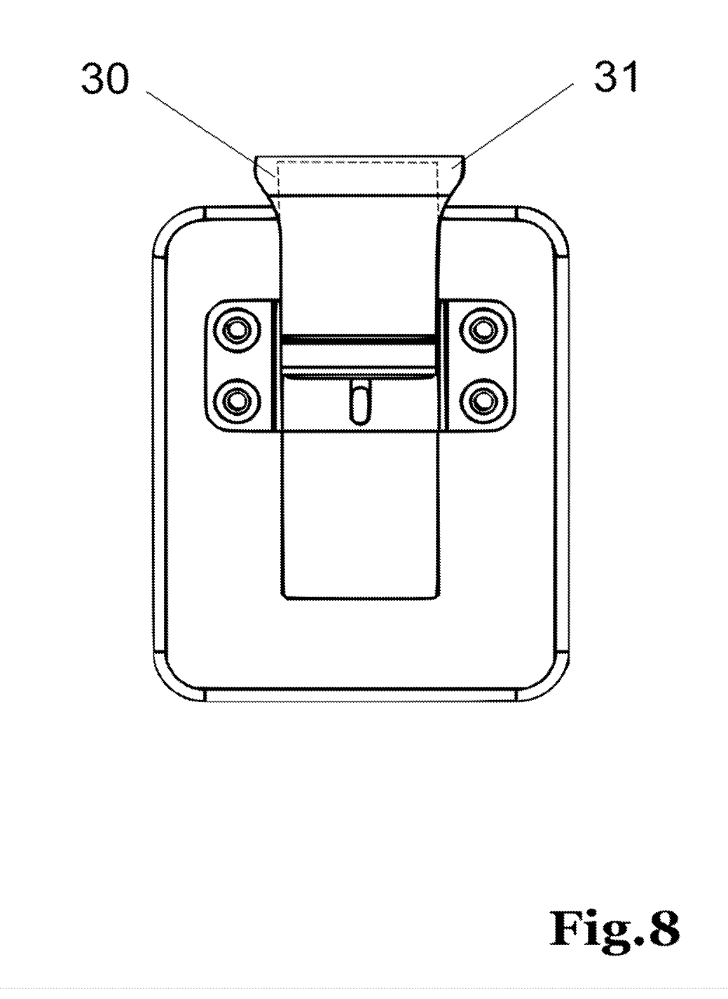

Referring now to FIGS. 7 & 8 illustrating a belt mounted holder assembly. The belt mounted holder assembly FIG. 7 works in union with the hook accessory of FIG. 4. A ridged material 27 of predetermined size and shape providing two parallel surfaces. Mounting on the frontal portion is a U-shaped bracket 28 which allows the hook accessory of FIG. 4 to securely engage within it. Mounting on the opposing side is a belt clamp 30 and a springy clip 31 biased towards applying pressure on the belt clamp 30 when engaged. The forementioned parts are secured to the ridged material 27 by mechanical fasteners 29. FIG. 8 shows one preferred embodiment of the springy clip 31 extending beyond the nested belt clamp 30 so that the extended portion may serve as a handle for a user to grasp when sliding the first piece up and away from the belt clamp 30 to release the clip from an article of clothing without grasping the second piece.

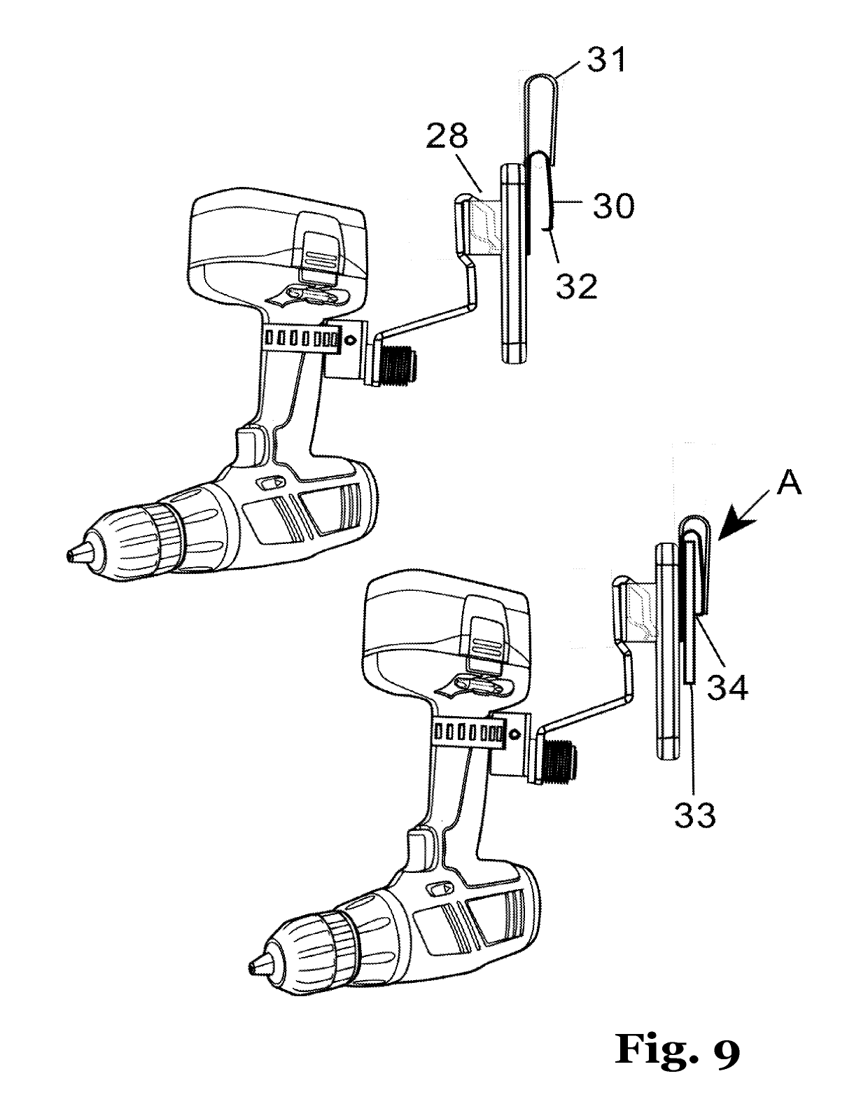

Referring now to FIG. 9 showing the belt clamp 30 provides an opening on the lower portion for a belt 33 to pass through. Downward pressure on the springy clip 31 secures the belt mounted holder to an article of clothing such as a belt by means of teeth 34 on the lower portion of the belt clamp 30.

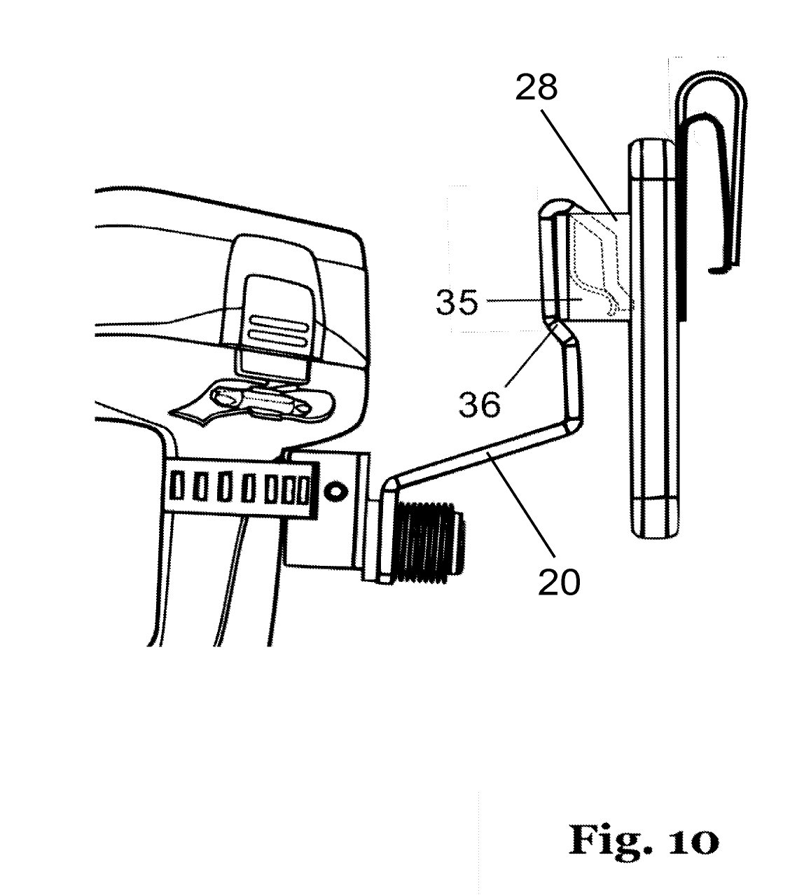

Referring now to FIG. 10 which illustrates a resilient locking system comprising a springy formed material 35 mechanically fastened to the U-shaped bracket 28. One preferred embodiment of this locking device is that the hook accessory of FIG. 4 may receive pressure from the springy formed material 35 when inserted into the U-shaped bracket 28 of FIG. 6 creating pressure at 36 causing the hook 20 to be locked within the U-shaped bracket 28.

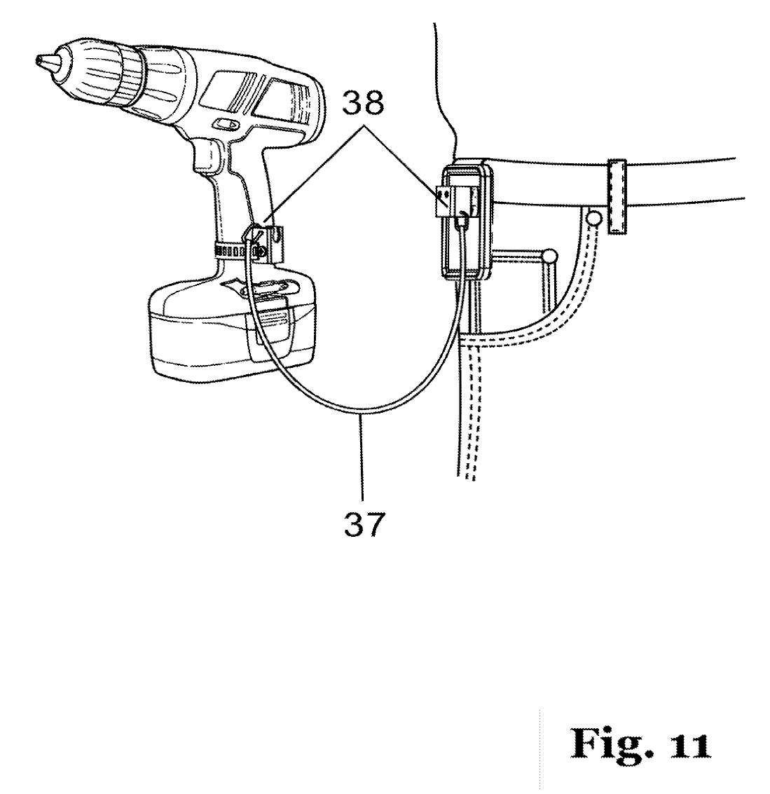

Referring now to FIG. 11 which illustrates a lanyard accessory 37 comprised of a flexible material and carabiners 38 attached to each end. The carabiners 38 clip into apertures that are provided in the ridged bracket 12 of FIG. 1 and the U-shaped bracket 28 of FIG. 7.

Referring now to FIG. 12 which shows a tool accessory pouch mechanically adapted to the tool accessory mounting device. This illustrates a preferred embodiment of how the mechanical fastening device may be used for additional accessories.

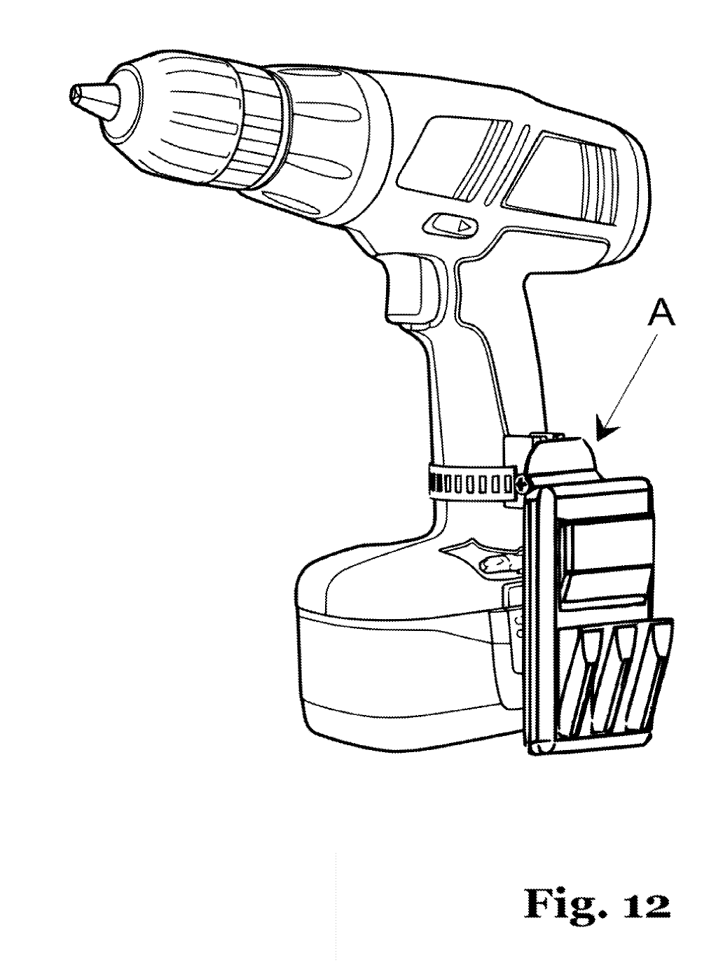

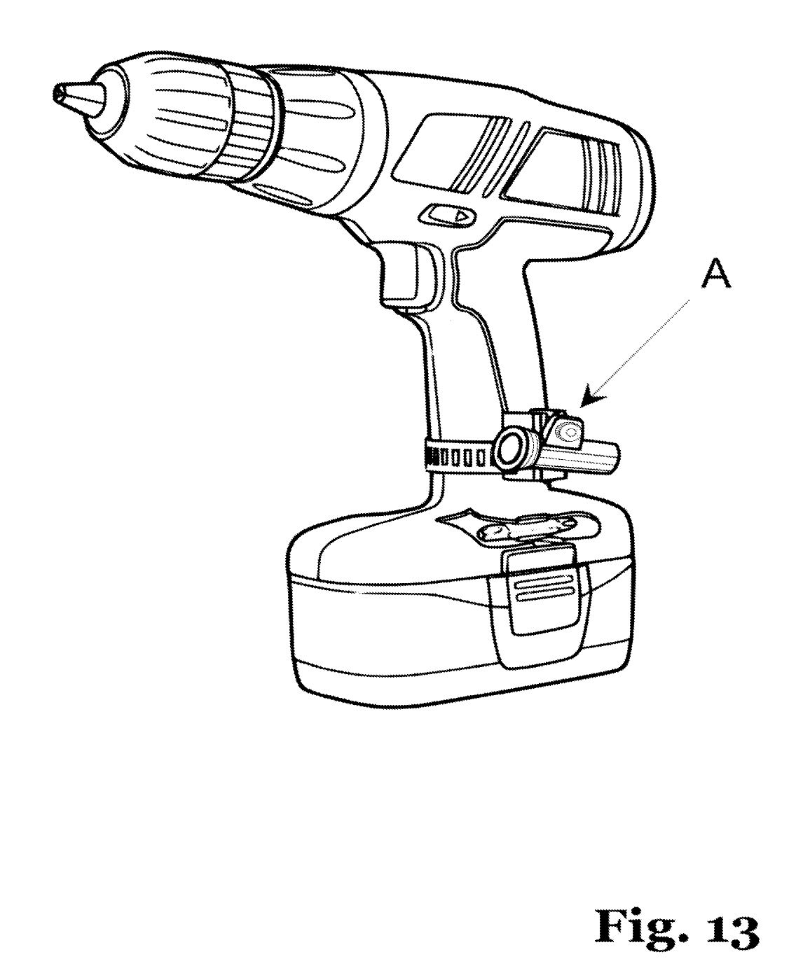

Referring now to FIG. 13 which shows a flashlight mechanically adapted to the tool accessory mounting device. This illustrates yet another preferred embodiment of how the mechanical fastening device may be used for additional accessories.

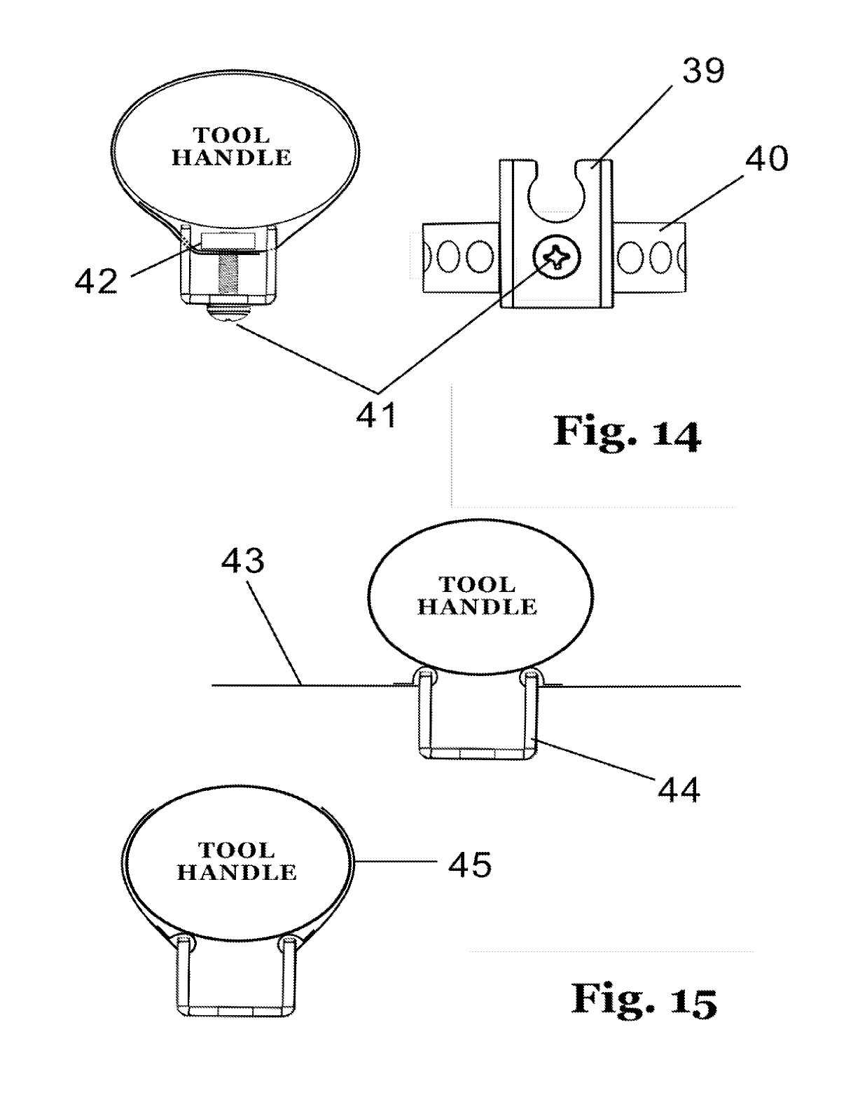

### FIGS. 14-18—Alterative Embodiments

Referring now to FIG. 14 which presents an additional embodiment of the mechanical fastening device of the present invention. FIG. 14 illustrates another preferred embodiment consisting of a flexible band 40 that has equally spaced circular apertures, a ridged bracket 39 that provides a cutout to receive a fastener, a tightening screw 41, and a square nut 42. The flexible band 40 wraps tightly around the tool handle so that the tightening screw 41 can pass through two aligned apertures in the flexible band 40 engaging the square nut 42. The screw can then be turned to tighten the flexible band.

Referring now to FIG. 15 illustrating yet another embodiment of the mechanical fastening device of the present invention consisting of adhesive coated flexible material 43 and a ridged bracket 44 capable of releasably receiving a fastener. The adhesive coated flexible material 43 would allow the bracket to be secured onto a tool handle or tool body.

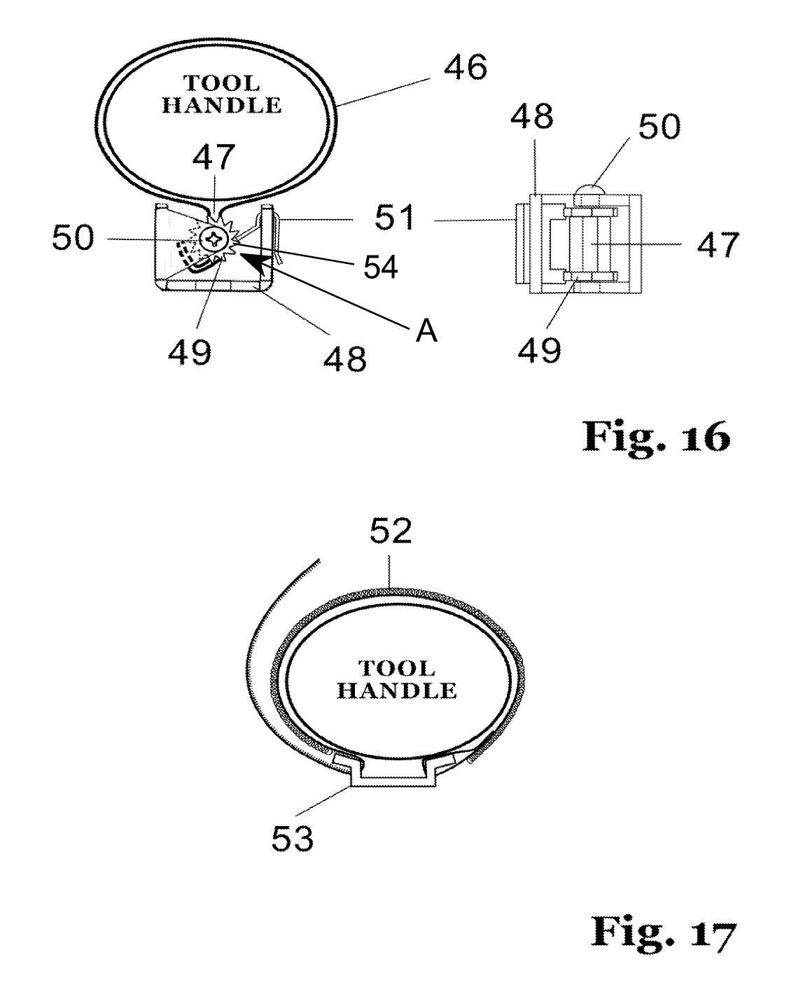

Referring now to FIG. 16 illustrating yet another preferred embodiment of the mechanical fastening device of the present invention comprising a band 46 and a ridged bracket 48 containing a racheting tightening system FIG. 16. The ridged bracket 48 also provides a cutout on the frontal portion that can releasably receive a matched fastener that is attached to an accessory. The racheting tightening system FIG. 16 consists of a ratchet wheel 54 that provides incremental adjustment teeth 49 that engage a catch 51 as the ratchet wheel 54 is turned by screw head 50, and a slotted opening 47 that allows both ends of the band 46 to pass through. Once the ends of the band 46 have passed through the slotted opening 47 the screw head 50 is turned. This binds the band 46 within the slotted opening 47 and engages the adjustment teeth 49 on the end of the catch 51 causing the band 46 to engage tightly around the perimeter of the tool handle.

Referring now to FIG. 17 illustrating yet another preferred embodiment of the mechanical fastening device of the present invention showing a hook and loop strap 52 and a ridged bracket 53 that provides a cutout to releasably receive a matched fastener. The strap 52 is shown permanently affixed to through an aperture in one side of the ridged bracket 53. Once the strap 52 is wrapped around the perimeter of the tool handle it passes through another aperture in the ridged bracket 53 doubling back upon itself engaging the hook to the loop and tightly holding the bracket 53 to the tool handle.

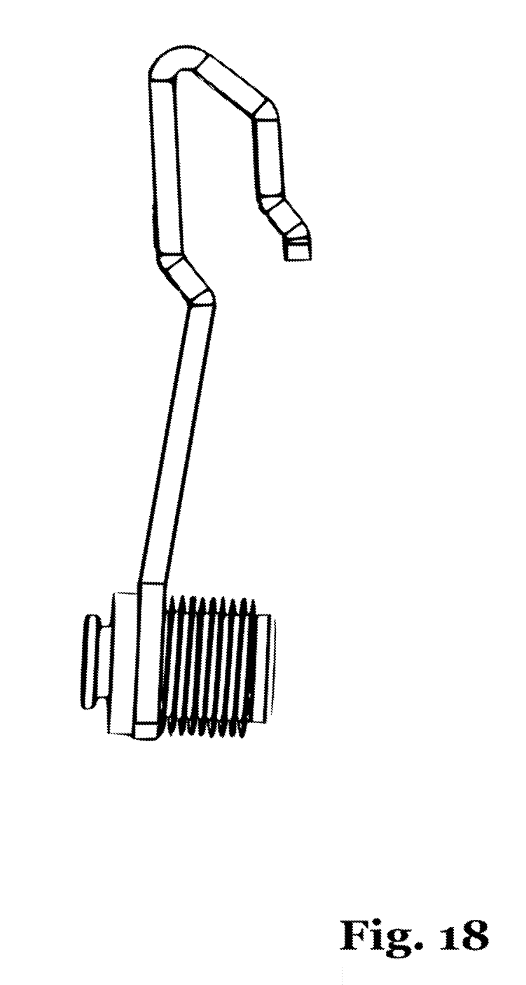

Referring now to FIG. 18 illustrating yet another preferred embodiment of the hook accessory of FIGS. 4 & 5, showing how the hook structure may be substantially varying in shape yet still within the scope and spirit of this invention.

Accordingly the reader can see that the tool holding device of the present invention will provide tool users with unmet safety features as well as the flexibility to tailor fit the accessories that they use throughout the day. By seamlessly attaching the mechanical fastening device to any sized tool handle, the user will be able to keep their tools close to them while they work. They can also be assured that by using the hook accessory as well as the lanyard accessory they will not harm another worker by dropping their tools. They also will now be able to protect their tools from being destroyed by dropping them. The design of the tool holding device also allows the tool user the comfort of not having an awkward safety device interfering with the task at hand. Further more the tool holding device provides additional advantages in that:
(a) It allows industry professionals the ability to climb ladders with both hands while carrying power tools of all sizes with them;
(b) It allows accessories to releasably attach to tools so they may be easily removed, allowing the tool user to return their tools to the cases;
(c) It provides tool users with unmet tool securing safety options all in one single device that is universal in it's design and function;
(d) It allows the user the ability to universally attach the mechanical fastening device easily and temporarily to tool handles;
(e) It does not interfere with the tool users grip on the tool as all of the preferred embodiments and alternative embodiments of the present invention provide a thin material for securing around the perimeter of the tool handle;
(f) It provides professional industries a professional grade option of tool securing and method of preventing damages to property and persons from dropped tools; and
(g) It provides workers the ability to keep their tools close at hand in all working situations so they are able to accomplish tasks quicker and more effectively.

### CONCLUSION, RAMIFICATIONS, AND SCOPE

Although the description above of the present invention contains many specifities, these should not be taken to limit the scope and spirit of this invention. These illustrations are merely showing a few of the presently preferred embodiments of this invention. For example the band that wraps around the handle of the tool can have a two piece band providing opposing teeth that engage themselves when the two bands are pinned against each other. The band can also be made out of any one of the many flexible materials that are currently available. The bracket can have a cutout opening to receive a matched fastener, or the bracket may also have a fastener on it that receives accessories providing a matched cutout. The spring clip may also have various means to use as handles to pull it upwards, such as: additional parts that are attached to it, and various ways of machining it so there is means to engage it manually and slide the spring clip in various directions for it to function.

Thus the scope of the present invention should be determined by the appended claims and their legal equivalents, rather than the examples which have been given.

What is claimed is:

1. A releasable tool holding device comprising:
a. a holder assembly having an attachment structure on one side for attaching to a user's clothing item such as a belt,
b. a hook structure with a proximal end and a distal end,
c. said holder assembly having on its other side a receiving structure configured to receive and releaseably hold the proximal end of said hook structure,
d. said hook structure releasably connected at its distal end to a fastening structure for wrapping around a tool handle and holding it securely.

2. The device of claim 1 further comprising:
said hook having a portion between its ends that extends away from the holder assembly so that when the proximal end of the hook is inserted into the receiving structure the distal end is positioned out and away from the holder assembly.

3. The device of claim 2 further comprising:
said proximal end of said hook forming a J like shape for hooking over and inserting into a portion of said receiving structure.

4. The device of claim 3 further comprising:
said receiving structure configured to receive and releasably hold the inserted proximal end of said hook and said receiving structure having a spring loaded locking structure exerting a clamping force against the inserted proximal end within said receiving structure to more securely hold the inserted end than gravity alone would.

5. The device of claim 4 further comprising:
said locking structure spring clamping force being sufficient to prevent inadvertent dislodgement of the inserted proximal end of said hook from said receiving structure but also allowing a user to overcome its clamping force and remove the inserted end by pulling the inserted end out of the receiving structure.

6. The device of claim 1 further comprising:
A pivot between the fastening structure and the distal end of the hook to allow a fastened tool to swing along the pivot axis and decoupling at least a portion of the tool swing motion from the user wearing the holder assembly.

7. The device of claim 1 further comprising:
A band on the fastening structure that can be loosened to encircle a tool handle and can then be tightened by a screw which is connected so as to reduce the diameter of the band to grip the tool handle as the screw is turned thereby more tightly gripping the encircled tool handle.

8. The device of claim one further comprising:
A rafter gripping biting structure on the hook positioned on the outward facing side of said hook relative to the holder assembly for biting into and thereby gripping a rafter and preventing sliding of the hook when the hook is disengaged from the receiving structure and hung on a rafter to secure an attached tool thereto.

9. A releasable clip for securely attaching an item to an article of clothing such as a belt or pant top said clip comprising:
a. A first piece configured to hook over the top edge of a clothing article, said first piece having opposed portions connected by a bend to form a structure that doubles back on itself and can hang over a clothing article that can fit between the opposed portions,
b. A second piece configured to hook over the top edge of a clothing article said second piece having opposed portions connected by a bend to form a structure that doubles back on itself and can hang over a clothing article that can fit between the opposed portions,
c. said first piece having a spring bias forcing the opposed portion of the piece towards each other,
d. said second piece having a spring bias forcing the opposed portion of the piece away from each other,
e. said second piece nested within said first piece with a substantial portion of said first piece overlapping said second piece,
f. said first piece configured to compress the overlapped portion of said second piece so as to move the opposed portions of the second piece towards each other to more firmly grip an item of clothing that is held between the opposed portions of the second piece,
g. said first piece configured to have a sliding engagement with said nested second piece such that when said first piece is slid up and away from said second piece, the force from the first piece which compresses the second piece's opposed portions closer together is diminished thereby allowing the spring force of the second piece to push the opposed portions of the second piece away from each other allowing release of an article of clothing that is held between the opposed portions of the second piece.

10. The device of claim 9 further comprising:
Said second piece having a gripping structure on one of its opposed portions extending towards the other opposed portion for engaging with an article of clothing that is held between the opposed portions and impeding the ability of the engaged clothing to slide out from between the said opposed portions.

11. The device of claim 10 further comprising
said first piece having an extended portion at or near the bend which extends beyond at least one edge or surface of the nested second piece so that the first piece's extended portion can serve as a handle for a user to grasp when sliding said first piece up and away from the nested second piece to release the clip from an article of clothing without grasping the second piece.

12. The device of claim 9 further comprising:
said item being a tool holder.

13. A mechanical fastening device for a tool holding device comprising:
a. a bracket configured to releasably connect to said tool holding device,
b. said bracket having a band for wrapping around a tool handle,
c. means for tightening said band to securely grip said tool handle.

14. The device of claim 13 further comprising:
said means for tightening being a screw mechanism connected to pull one end of the band as the screw is turned; the other end of the band being affixed to the bracket such that when the screw is turned in one direction the diameter of the band increases and when turned in the other direction reduces the band diameter so as to securely grip the tool handle.

15. The device of claim 13 further comprising;
said bracket also configured to releasably connect to a tool accessory when not connected to the tool holding device using the same connecting structure to connect to the tool accessory as is used to connect to the tool holding device.

16. The device of claim 15 further comprising:
said tool accessory being one of the following:
a. a tool bit container,
b. a flashlight.

17. The device of claim 13 further comprising:
a. said tool holding device having a generally round fastener affixed thereto for releasably connecting to said bracket,
b. said fastener passing through an aperture in said tool holding device,
c. said fastener having enlarged portions at each end that have a larger diameter than said aperture,
d. said bracket having a generally round cutout opening that fits over and pivots around said generally round fastener,
e. said tool holding device having a spring coaxially mounted on said fastener for forcing one end of said fastener towards one side of said aperture to firmly hold said bracket to said device when said cutout opening is positioned over said fastener,
f. said firmly held bracket being more easily releasable when a user compresses the coaxial spring by pushing on one end of said fastener thus reducing the force which pulls the other end towards the said one side of the aperture and keeps said connected bracket firmly held against said device,
g. said fastener being released by compressing said spring and then lifting said fastener from said cutout opening off of said bracket which partially encircles said fastener.
